(19) United States
(12) Patent Application Publication
(10) Pub. No.: US 2002/0046230 A1
(43) Pub. Date: Apr. 18, 2002

(54) METHOD FOR SCHEDULING THREAD EXECUTION ON A LIMITED NUMBER OF OPERATING SYSTEM THREADS

(76) Inventors: DANIEL J. DIETERICH, ACTON, MA (US); JOHN B. CARTER, SALT LAKE CITY, UT (US); SCOTT H. DAVIS, GROTON, MA (US); STEVEN J. FRANK, HOPKINSON, MA (US); THOMAS G. HANSEN, LEOMINSTER, MA (US); HSIN H. LEE, ACTON, MA (US)

Correspondence Address: Proskauer Rose LLP, 1585 Broadway, New York, NY, 10036, US

(21) Appl. No.: 09/069,352

(22) Filed: Apr. 29, 1998

(51) Int. Cl. G06F 15/163; G06F 9/54; G06F 9/00

(52) U.S. Cl. 709/107

(57) ABSTRACT

A system for scheduling thread execution on a limited number of operating system threads inside a kernel device driver and allowing execution of context threads by kernel mode threads includes a kernel device driver that itself includes at least one kernel thread. A data structure stored in a memory element is associated with a context thread to be executed by the system. A flow scheduler stores context thread state in the associated data structure and schedules the execution of one or more context threads.

### CROSS-REFERENCE TO RELATED APPLICATIONS

The present application claims the benefit of co-pending provisional application Serial No. 60/045,701 filed May 2, 1997.

### FIELD OF THE INVENTION

The present invention relates to process flow scheduling and, in particular, to scheduling the execution of operating system threads within a device driver.

### BACKGROUND OF THE INVENTION

Many multithreaded operating systems, such as Windows NT and Windows 95 manufactured by Microsoft Corporation of Redmond, Wash., provide kernel threads for performing tasks in and to protected kernel memory. However, kernel threads require large amounts of reserved kernel memory and context switching between kernel threads is typically slow, but frequent. As a result, use of kernel threads is typically restricted in order to minimize consumption of CPU time and memory. Use of kernel threads is further restricted because some kernel threads are used by the operating system to perform system tasks.

It is sometimes desirable to implement threaded, application-like functionality within an operating system component, such as a device driver. For example, Windows NT and Windows 95 both provide an Installable File System (IFS) interface that must be exported from within a device driver. Applications supporting the filesystem Application Programming Interfaces (APIs) must be implemented as an IFS and, therefore, must be implemented as a device driver.

Windows 95 uses the Windows Virtual Device Driver (VxD) model to implement device drivers. It provides services through the Virtual Machine Manager (VMM) and other VxDs. The interface exported from a Virtual Device Driver is defined using a unique driver number and service number. In addition, the VXD can implement an I/O control (IOCTL) service to provide an interface to Win32 applications. However, since device drivers compete for a limited number of kernel threads, it is generally not possible to assign each of a large number of application threads, sometimes called context threads, to a unique kernel thread. Accordingly, complex, multithreaded application-like functionality implemented within a device driver may become capacity-limited because not enough kernel threads are available to allow continuous processing. Lack of available kernel threads can result in deadlock when active threads, i.e., threads assigned to a kernel thread, are waiting for the result from a thread that cannot be assigned to a kernel thread because they are taken.

### SUMMARY OF THE INVENTION

The present invention relates to an in-kernel execution environment supporting application-like functionality inside of a device driver, complete with “roll back” and “roll forward” features. Due to the restrictions imposed by operating systems on code running inside of a device driver, mainly, the limited number of kernel threads available for execution as context threads, the multiplicity of context threads must be multiplexed onto a smaller number of kernel threads in much the same way that many executing processes are scheduled for execution on a single processor. Thus, the present invention relates to a flow scheduler that may be thought of as a virtual machine operating inside a device driver.

### BRIEF DESCRIPTION OF THE DRAWINGS

The invention is pointed out with particularity in the appended claims. The advantages of the invention described above, as well as further advantages of the invention, may be better understood by reference to the following description taken in conjunction with the accompanying drawings, in which:

FIG. 1 is a block diagram of one embodiment of a flow scheduler according to the invention;

FIG. 2 is a block diagram showing a single sequential operation by the flow scheduler of FIG. 1;

FIG. 3 is a block diagram showing two parallel operations by the flow scheduler of FIG. 1; and

FIG. 4 is a block diagram showing the flow of an asynchronous call to the flow scheduler of FIG. 1.

### DETAILED DESCRIPTION OF THE INVENTION

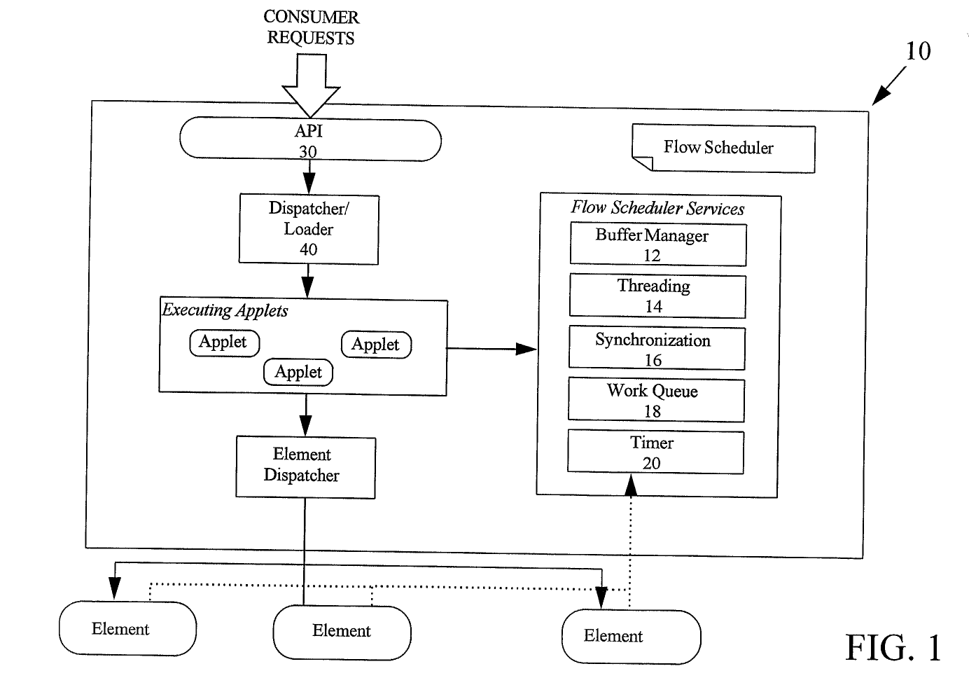

Referring now to FIG. 1, a block diagram of a flow scheduler 10 is shown that can “multiplex” many context threads on to a small number of kernel threads. The flow scheduler 10 schedules the execution of context threads so that maximum context thread work is accomplished. This may be thought of as the same way that an instruction dispatch unit within a processor must schedule instructions for processing. For example, if an executing context thread must “block,” i.e. wait, pending a future event, the flow scheduler 10 must be able to stop the execution of the context thread, save the associated state of the context thread so that it may be restarted whenever the pending future event occurs, and then begin execution of a second context thread on the kernel thread while the first context thread is blocked. This facilitates the creation of complex, blocking functionality within a device driver.

The flow scheduler 10 thus provides an environment to load and execute a set of context threads represented by applets or elements, both of which are described in more detail below. The flow scheduler 10 optionally can run in an interpreted manner. FIG. 1 depicts one embodiment of the internal architecture of the flow scheduler 10. A flow scheduler 10 includes a number of services that may include: buffer and memory management services 12; threading services 14; synchronization services 16; execution work queue services 18; and timer services 20.

The threading service 14 is designed to allow synchronous, asynchronous, and parallel execution of context threads, which are created in response to consumer requests or requests made by other context threads. As noted above, it is not reasonable to provide a one-to-one mapping between context threads and kernel threads (i.e., operating system threads in the case of, for example, Windows NT, or internally-created representations of kernel threads in the case of, for example, Windows 95). It may be necessary for the flow scheduler 10 to service a larger number of consumer requests than existing kernel threads, a single consumer request may spawn a number of further context threads to execute subtasks associated with the consumer request, and some kernel threads are used by background tasks necessary for operation of the operating system. Also, each executing kernel thread generally requires substantial overhead. Although it may be reasonable for some multithreaded operating systems to create a work queue of between five and twenty-five threads, using hundreds of threads generally requires too many resources from any operating system and does not scale well. Rapacious consumption of system resources also prohibits dynamically “forking” kernel threads to (1) perform short-lived (or logically parallel operations) or (2) wait indefinitely for an event to occur. Forking is a necessary element in the creation of complex, multi-threaded, resource-intensive operations and the described design supports this ability, which is required for such programming.

In many cases, context threads will issue local filesystem reads and writes or network communications requests, during which the context thread will be idle pending I/O completion. The threading service 14 of the flow scheduler 10 allows the use of the kernel thread to service other context thread requests while the idle context thread waits for I/O to complete. This arrangement avoids “blocking” the kernel thread by not directly associating requesting context threads with a particular kernel thread. Context threads are mapped dynamically onto kernel threads, allowing the flow scheduler 10 to service many more context threads than there are available kernel threads. The mapping or assigning of context threads to kernel threads is performed in conjunction with the work queue services 18.

The threading service 14 provides an encapsulated virtual context object, referred to throughout this discussion as an Execution and Dispatch object (ED object). The threading of applets requires fully reentrant, asynchronous code; that is, all operation context must be maintained in a per-operation, per-layer control structure. ED objects provide this structure by means of tree structured linkages. An operation at any level can create associated (children) operations and these can be easily tracked for completion and error recovery purposes. A chain of context objects makes up a context thread, which can be transparently mapped to a kernel thread and provide seamless context for the context thread.

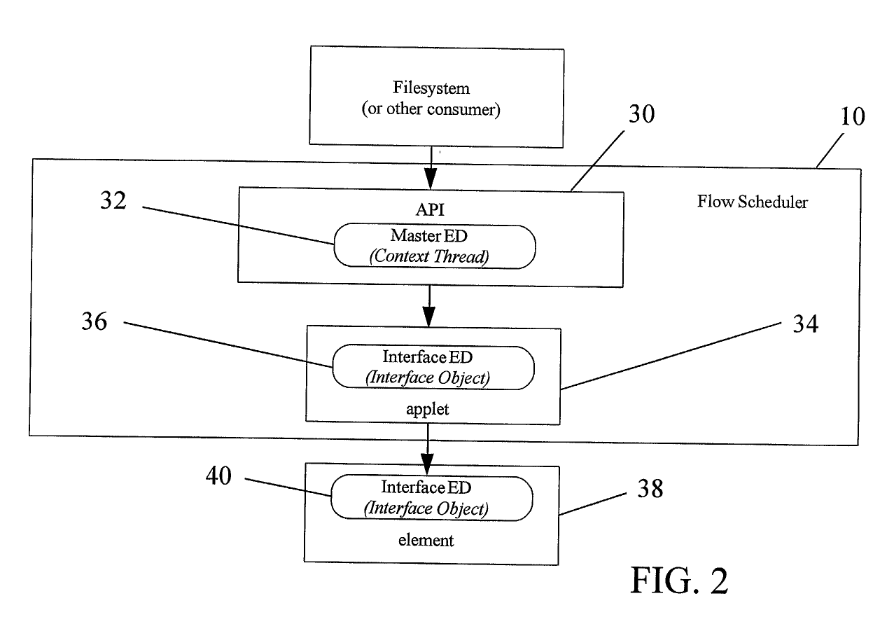

The threading interface between applets and all associated elements is object-based. An ED object is created at each control transfer point in the context thread execution flow and linked into the context thread. In effect, each ED object represents a quanta of context thread work that can be performed without blocking or waiting for another resource. Thus, ED objects are the unit of work dispatched by the flow scheduler 10 to applets and elements. A simple sequential ED object flow is illustrated in FIG. 2. A consumer (such as a filesystem) makes a call to the API 30, which creates a request context thread. The created context thread contains a base object, called the master ED object 32, representing the executable context within the flow scheduler 10 and provides services for scheduling the created context thread. The request is dispatched to an applet interface 34 derived from an ED object interface called the interface ED object 36. This ED object contains the stack for the applet interface, including the execution pointer. As ED object derived interfaces are created during context thread flow, they are linked into the context thread. The set of linked interface ED objects corresponds to the flow of control of the operation invoked by the consumer, that is, they correspond to the series of suboperations that must be performed to complete the operation invoked by the consumer. The active ED object is maintained in the master ED object 32 to identify the currently executing context thread. The term “invoke” will be used to indicate a dispatch to an ED object derived interface to distinguish it from a traditional C dispatch, which will be referred to as a “call.” When an interface is “invoked,” the execution pointer stored in the master ED object 32 is set to identify a function to be executed. Each invocation causes a transfer of control back to the flow scheduler 10 so the interface resets this execution pointer across invocations of other interfaces in order to maintain its execution flow.

The flow scheduler 10 runs the active ED object's execution pointer until there is no active ED object, which is an indication that the request has completed. This model of operation abstracts asynchronous and synchronous request flow from the applets and most of the elements; therefore, the interfaces need not know whether an invocation is occurring synchronously or asynchronously.

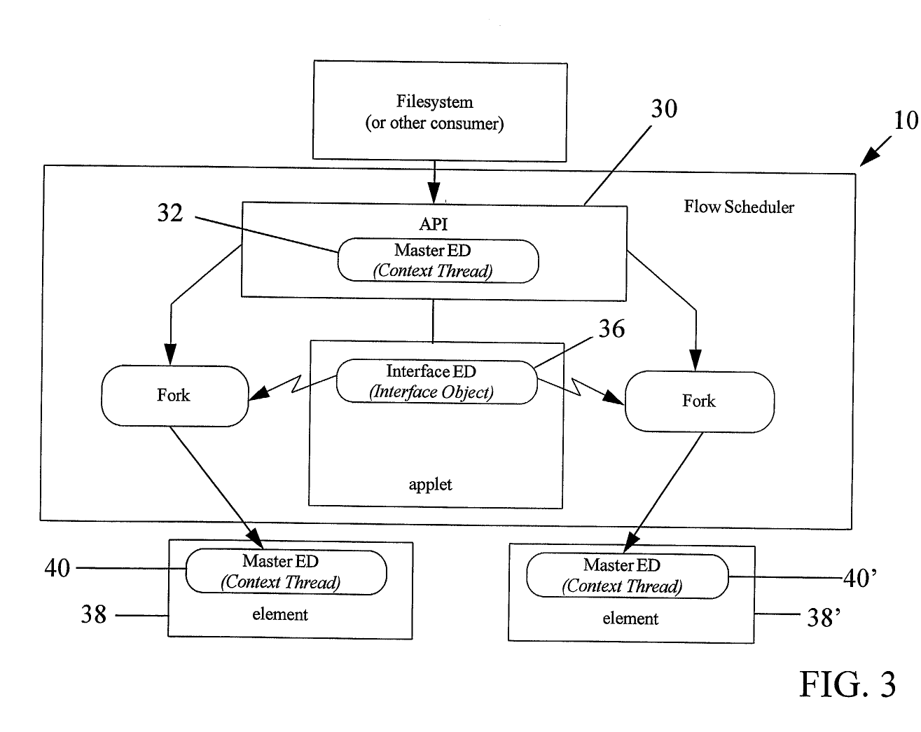

The threading service 14 supports parallel request invocation of threads by providing a forking construct as illustrated in FIG. 3. This allows a context thread to appear to simultaneously do two things. Any context thread can invoke parallel execution contexts by calling thread service primitives. These create a fork object linked to the parent and an associated context thread. The context thread can issue any number of parallel requests. Each of the parallel requests being serviced is a separate context thread. The parent can wait for one, any, or all child context threads to complete. This model provides utilization of the bandwidth available on multiprocessor nodes. Parallel invocation also allows a single request to begin multiple I/O requests concurrently; this ability can have a dramatic effect on performance, as it is designed to better utilize the computer power and I/O bandwidth available on certain machines.

The thread services 14 of the flow scheduler 10 also include synchronization capabilities. Synchronization is performed via implicit and explicit functions. In synchronous operations, synchronization is implicit. The flow is managed by the master ED object 32 controller. It dispatches the context thread to the active ED object and maintains execution coherence. The dispatched context thread runs in the kernel thread until the operation completes. Asynchronous processing also uses the master ED object 32 controller to dispatch execution. However, the context thread may transition to other kernel threads during its life and require explicit calls to run on other kernel threads. The master object 32 manages this transition. In both synchronous and asynchronous modes, the controller uses the active ED object's execution pointer to dispatch the thread. As applet or element processing continues, the current execution pointer, and therefore the current execution state, is constantly changing. This allows both synchronous and asynchronous requests to maintain coherence. When an asynchronous context thread completes in the flow scheduler 10, a completion routine passed to the API 30 and stored in the master ED object 32 is executed by being passed the status of the operation. This routine is the hook needed to reinitiate processing by the requesting consumer.

Parallel operations are, by definition, asynchronous. They require the ability of a parent ED object to initiate parallel, asynchronous operations and then wait for some or all of the sub-operations to complete. The mechanism provided is the combination of separate request completion routines and a synchronization primitive provided by the thread services 14. The completion routines allow processing on a per-operation-completion basis. The synchronization primitive is a logical AND function on all child invoked ED objects. The ED object does not resume until all children have completed. A wait primitive provided by the synchronization services 16 also can be used to perform synchronization between multiple context threads in conjunction with a signal primitive.

In general, the synchronization objects provided by the operating system should not be used for synchronizing events in the flow scheduler 10 because they will stall execution of the operating kernel thread, not just the flow scheduler context thread. This is particularly true for those synchronization objects that may cause a “wait” lasting for long intervals or those that are used across invocations. Although using operating system synchronization services can work, they may cause the operating system thread to stall, which can exhaust the flow scheduler's execution thread work queue. When this occurs, the operating system, and therefore the node on which the operating system is executing, may deadlock.

The synchronization services 16 of the flow scheduler 10 are designed not to stall the operating system kernel thread, but rather to stall the context thread. The model used for the synchronization services 16 allows the flow scheduler 10 to run with any number of available operating system kernel threads without risk of deadlock or request starvation. It provides a general purpose synchronization object between applets and elements called a sync object. This object and the set of services it provides are used as a mutex (mutual exclusion semaphore) or a long-term lock within the node. The sync object contains two separate states, locked and bound. The locked state is used to protect access to a resource, and the bound state indicates whether a particular context thread currently owns the lock. The sync object can be: locked and bound, locked and unbound; or unlocked and unbound. A locked sync object that is not bound to a context thread allows a synchronization lock to be held across applet invocations. This provides a long-term lock, such as a read-only lock on a page of data. An unbound sync object may be unlocked by any context thread, not just the context thread that locked it. This provides a lock that can be removed if another operation (context thread) frees the resource. A sync object also can be used to signal events between context threads. The lock state is abstracted as an event state and the lock wait list is used as the event wait list. When a sync event is locked, it is considered to be in the reset state or non-signaled. This will cause context threads that wait on the event to block. When the sync is unlocked, the event is signaled and one or more waiting context threads will wake up.

The threading services 14 of the flow scheduler 10 provide for exception handling by allowing each interface object to register an exception handler. The flow scheduler 10 will call the registered routine and pass an indication of the kind of exception to the registered handler when a lower level interface generates an exception. During normal operations, the exception handler is called when the context thread is scheduled to run. An interface, therefore, is not required to account for reentrancy. However, the flow scheduler 10 provides for true asynchronous exception delivery when it is desirable. This may be the case for lower level interfaces that are performing I/O operations that may take some time to complete. An interface must explicitly enable asynchronous exception delivery. In general, for exception handling to work correctly, either all or none of the interfaces should provide for exception handling with the context thread. The flow scheduler 10 will continue normal execution even while an exception is outstanding if the active interface has not provided an exception handler. This may be a problem when a lower level interface generates an exception when its parent does not provide an exception handler. It will continue execution as if the exception did not happen. However, this may be acceptable for timeout and cancel exceptions. The timeout or cancel is handled as soon as possible but may be deferred to a higher level interface better capable of handling it.

The flow scheduler 10 implements time-out and cancellation using the exception primitives in the thread services 14. The timer service 20 provides request time-out tracking that is transparent to the applets and elements. In conjunction with the threading services 14, requests that are issued with a time limit have their context threads placed in a sorted list contained within the timer service 20. The timer service 20 then processes the list using a periodic timer interrupt provided by the operating system through the operating system's platform abstraction library (PAL). The timer sorts the list in order of time-out expiration to avoid searching the entire list on every timer interrupt. The timer maintains a value indicating the next expected time-out interval and avoids any checking of the time-out list until this time interval is reached.

When a context thread is timed out, the active interface's exception handler is called. To prevent excessive synchronization within the threading services 14 and reentrancy control within the applets and elements, the exception routine is not called asynchronously on the interface that is currently executing. The existing execution function is allowed to complete before timeout or cancel is signaled. Although this behavior helps simplify time-out and request cancellation, it may not be desirable when an element is executing a synchronous I/O operation. To help solve this limitation, the threading service 14 provides primitives to place the active ED object into a state which will accept asynchronous exceptions. In this mode, time-out or cancel processing may call the exception routine for the active ED object while the ED object is executing. The threading services 14 will use a lock to prevent damage to internal data structures. The element may also need to provide locks for any data associated with its exception routine, since two execution threads may be executing in the same ED object context concurrently. An asynchronous exception is typically used by elements providing access to I/O devices with an unpredictable latency. When servicing a synchronous request, these elements will block the execution thread awaiting I/O completion. The asynchronous exception will allow the element to cancel the I/O operation which in turn will return the execution thread to the element.

The buffer manager 12 of the flow scheduler 10 allocates and returns memory objects used by elements and applets within the flow scheduler 10 to: prevent fragmentation of memory; detect memory leaks and track consumer memory usage; use common memory allocation tracking and storage between allocations; apply back pressure to greedy elements; and optimize allocation of common memory objects. The memory allocated and deallocated is static storage implemented using efficient heap storage management. Both the applets and elements get and return buffers of different types. In some cases, the buffers persist for a long time as they are consumed by an element, such as local RAM cache consuming a page received from a remote operations service. In many cases, the buffers persist for the life of a context thread flow and in some cases buffers persist only until a certain point in a context thread flow.

The buffer manager 12 provides services through a buffer service object and a set of storage pools. Four distinct pool types can be created through the buffer services: the buffer pool; the page pool; the cached page pool; and the heap pool. The buffer pool is the most efficient of the storage pools, and it is used to provide small, fixed-size buffers. The page pool is nearly as efficient and provides block aligned storage objects of a fixed size. Unlike the buffer pool, the page pool separates the user buffer and storage headers to make certain that the storage is aligned on operating system page boundaries. The cached page pool will dynamically reclaim storage as memory demands increase. The final pool type is a heap pool that provides for allocation of variably sized memory objects.

The pools of the buffer service 12 provide storage through operating system heap and page allocation of paged and non-paged memory. The buffer pools allocate blocks of storage and divide the blocks between the pools in an effort to avoid fragmentation of memory within the operating system. Two types of fragmentation are a consideration for the buffer manager 12, physical memory fragmentation and linear address space fragmentation. The buffer manager 12 prevents physical memory fragmentation by always allocating storage on physical page boundaries. If possible, the operating system PALs will prevent linear address space fragmentation by reserving a portion of the linear address space within paged and non-paged address space and commit physical storage as needed. If the operating system does not provide this capability and linear address space fragmentation is a problem for the operating system, the operating system PAL may allocate a large contiguous block of memory from the operating system and divide the block between the pools as required.

The buffer manager 12 incorporates extensible buffer tracking software. Some of this software may be switched on as a debug option. Software to track buffer usage of particular applets or elements runs continuously and can be used to apply back pressure to greedy elements in times of tight resource utilization.

A buffer service object provides two default heap pools that are not associated with any particular applet or element and that are available to any applet or element that needs to allocate memory but does not require one of the local pools described above. These pools should not be used indiscriminately in place of local pools, because they prevent tracking of allocations to a specific applet or element. Also, the heap pool better prevents memory fragmentation when used within a specific subsystem rather than as a global resource to all subsystems. However, in situations where an element or applet has a small, short-lived need for a buffer, such as allocation of a buffer to contain a string, creating a local pool in order to allocate the buffer will incur too much overhead. However, elements should generally create local pools, including local heap.

The timer service 20 provides a periodic timer that is available for all of the elements. It provides an API that allows an element to register a periodic timer callback function and a context data pointer. The timer service 20 provided by the flow scheduler 10 prevents multiple elements from using operating system timers, which are often a scarce resource. It registers a single operating system timer and provides an unlimited number of registered callbacks for elements. In one embodiment, the period timer is set to a resolution of 100 milliseconds, and it generally will be changed as required by the elements.

The work queue service 18 is responsible for mapping context threads onto kernel threads. The thread work queue is designed to run using as few as one kernel thread. However, the typical configuration will allocate a plurality of kernel threads. Providing more than one thread allows the flow scheduler 10 to run multiple context threads concurrently. On a uniprocessor node, the operating system will divide CPU cycles between the tasks. This causes all active context threads to share the processor time. However, on a multiprocessor node, multiple context threads may be executed simultaneously.

The thread work queue services 18 are used for asynchronous requests and daemon tasks. When an operating system thread becomes available in the work queue, it runs the context thread. If device I/O (to local disk or to the network) is required, the operating system thread returns with a pending status and becomes available to service other context threads. The initial request is placed back into the work queue when the I/O completes.

As noted above, the flow scheduler 10 is invoked in response to a request from a consumer. A consumer request may be the result of network input or a local operation, such as a filesystem read or write request. The consumer request contains an opcode and possibly other parameters. The opcode is parsed by the flow scheduler 10 and results in the internal execution of an applet. The applet executes a sequence of element invocations that perform the requested operation. The applet provides for both parallel execution and dynamic control flow.

Applets and elements recursively issue requests to the flow scheduler 10 as part of their normal processing activity. These requests appear as opcodes similar to invocations from consumer requests. The flow scheduler 10 is required to maintain context for each invoked request that is currently active and flowing through the system. The context is used for per-request context variables and may be used to pass arguments to the elements.

The flow scheduler dispatcher/loader 40 performs the initial processing on requests received by the API 30. Each received request can include an opcode, a number of arguments, a time limit, a set of control flags and an optional completion routine, user context data pointer, and request handle pointer. The flow scheduler 10 uses its threading services 14 to create a context thread for the request it is servicing. It parses the input opcode and uses it to load and execute applets using the context thread. The flow scheduler dispatcher/loader 40 abstracts the applet from all consumers. This allows the internal structure of an applet to change without affecting its consumers.

Applets embody algorithms for performing operations that are stateless, i.e., there are no global variables or data structures available to applets. All data that is processed by the applets are either encapsulated objects or system-owned structures. Any state needed for the life of an applet must be stored in a thread context object.

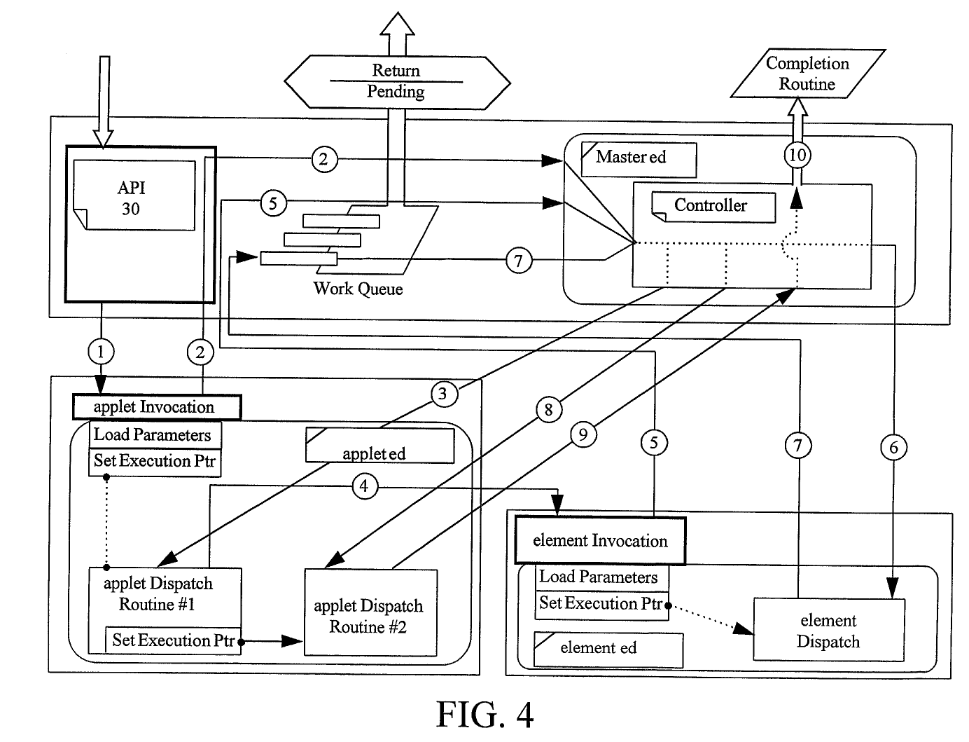

In the asynchronous case, an invocation of an applet or element will result in a transfer of control to the flow scheduler 10 and thus prevent execution to continue within the current function. An example of the flow for an asynchronous request is shown in FIG. 4. To aid in understanding the flow of control related to such a request, each transfer of control is numbered in FIG. 4 and described below in corresponding numbered paragraphs.

1. The call of the API 30 from a consumer causes the flow scheduler dispatcher/loader 40 to create the context thread and an associated master ED object. It also loads and invokes the applet that corresponds to the opcode provided in the call. The applet creates its interface ED object, initializes parameters within that object, and sets the execution address to its dispatch routine.

2. The applet returns control to the flow scheduler 10 which invokes the master ED object controller.

3. The controller dispatches the active ED object's execution routine, in this case the “applet Dispatch Routine #1”.

4. The applet resets is execution address to its next state (“applet dispatch Routine #2”) and invokes an element. The element creates its interface ED object, initializes parameters within the object, and sets the execution address to its dispatch routine.

5. The element returns control to the flow scheduler 10 which invokes the master ED object controller.

6. The controller dispatches the element's execution routine.

7. If the invoked operation must block pending an event, the element dispatch routine sets the context thread status to pending and returns control to the flow scheduler 10. This causes the request to be placed on the work queue and the execution thread is returned to the caller with status set to pending.

8. When the element's I/O operation completes, it completes its ED object and wakes the control thread in the work queue which in turn calls the master ED object controller to restart request dispatching. It dispatches the next active ED object's execution routine which is the “applet Dispatch Routine #2.”

9. The applet completes its ED object and returns control to the flow scheduler.

10. The flow scheduler's master ED object controller determines that there is no active ED object and calls the asynchronous completion routine provided by the caller passing the status of the request.

### EXAMPLE

Using a distributed shared filesystem as an example, it would be desirable to use the mechanisms described above to implement a minimum set of synchronization primitives needed to support efficient execution of four major filesystem operations; specifically: reading from and writing to shared data; byte range locks; oplocks; and internal synchronization of filesystem metadata. Synchronization primitives for these operations should provide: (i) efficiency in the common failure-free, low lock contention case, (ii) simplicity of implementation, and (iii) the ability to tolerate partial system failures with acceptable recovery overhead.

This example provides two types of synchronization support: controlled locking and unlocking of memory pages and a mechanism for signaling (waking up) applets on remote nodes. These two mechanisms can be used to support efficient reading and writing of shared memory pages and serve as the primitives upon which more complex synchronization operations (e.g., byte range locks) can be built.

In this example, nodes should already support the ability to locally lock (in shared or exclusive mode) a copy of a memory page on that node. When a page is locked in exclusive mode, any remote reads or invalidate requests for that page are delayed until the page is unlocked. When a page is locked in shared mode, read requests from remote nodes for the page can be satisfied, but invalidate requests must be delayed. This mechanism allows a thread to operate on a page without worrying about whether or not other nodes are accessing the page. This allows efficient short-lived operations on pages (e.g., reading the contents of a file block to a user buffer or updating a filesystem metadata structure).

This design example provides two additional APIs (LockPage( ) and UnlockPage( )) that allow clients to lock pages for an indefinite amount of time in shared or exclusive mode, until the client either voluntarily unlocks the page or fails. This is roughly analogous to a client acquiring a page of memory in shared or exclusive mode and then pinning the page. With this facility, the filesystem will be able to pin pages into memory briefly while updating metadata structures (or, in the case of the filesystem, copying the data to a user buffer).

Because locking a page on a node can delay remote operations for an arbitrary amount of time until the page is unlocked, it is expected that applets will only lock a page into memory when they expect that the operations being performed on the page will be short-lived. In general, applets should not lock pages on a node and then perform remote operations without unlocking the page.

To provide an efficient way for an applet to wait for an asynchronous signal from an applet or a remote node, a form of remote signaling capability is provided. For example, an invalidation callback facility may be provided to inform nodes when a page they are holding is invalidated. The problem with using this facility for general purpose remote signaling is that it tends to be overly heavyweight and non-node-specific in its implementation, it only supports broadcast signals to all nodes waiting for a particular page. This example provides a mechanism that overcomes this problem by supporting a generalized remote signaling mechanism that allows applets to allocate objects called condition variables, pass handles to these objects to other applets (e.g., by storing the handle in shared memory), and go to sleep until another applet uses the handle to signal the sleeping applet that whatever operation it is waiting on has completed. In conjunction with the page locking operations described above, this generalized signaling mechanism is sufficient to support moderately efficient byte range locks and oplocks.

Remote signaling requires a means by which a thread can sleep on an event object and be awoken by a remote applet. Remote applets identify the event object that needs to be signaled using a “handle” that is allocated by the blocking thread. We introduce a condition variable type to map from this handle to a callback routine in which the event object can be signaled. An implementation of condition variables is described in more detail below. Since the Flow Scheduler already manages synch objects, it is the best candidate for managing condition variables. It is free to pass whatever handle it wants back to clients, but for simplicity and efficiency, it could use a combination of a identification code and a pointer to the condition object itself. To detect spurious signals, meaning signals using bogus or malformed handles, the condition variable itself could include some form of code that identifies it as a condition variable. The code should be selected so that it is unlikely to randomly appear at a particular word in memory, e.g., a pointer to itself.

Two new sets of APIs may be provided to support condition variables. There needs to be a mechanism for allocating handles and mapping them to the underlying event objects on which a thread can wait. There also must be a means by which a applet can signal a condition variable and wake up the applet blocked on the signal. The first set of operations, allocating and mapping handles, are operations local to the respective node. Part of the handle can be the identification handle of the node where the applet is blocked, so no coordination between nodes is needed when allocating condition variable handles. Handles could be anything from small integers, if they are merely an index into a table of pointers, to pointers in local system virtual memory to the condition variable data structure itself, depending on the level of trust envisioned between consumers of the synchronization mechanism.

The normal use of condition variables is shown below, where the steps in italics are performed by an applet created on demand by the remote operations service when the signal message is received:

Applet on Node1

Allocate kernel event object

Allocate condition variable

Store handle in shared memory

Block on kernel event object

Applet on Node2

Perform operation applet is waiting for

Read handle from shared memory

Signal condition variable (using handle)

Continue processing

Receive signal message

Perform callback function

Signal kernel event object

Resume processing

Given the ability to lock pages locally on a node and mechanisms to allocate, store, and signal condition variable handles, byte range locks in a distributed filesystem could be implemented as follows:

1. The filesystem allocates a page (or sequence of pages) for each open file with byte range locks into which it will store its own data structures needed to manage the byte range locks for this file. These data structures may consist of two lists of lock records: held locks and pending lock requests.

2. When an application wants to byte range lock a particular file, its local filesystem agent needs to acquire and lock an exclusive copy of the relevant byte range lock page(s), and search the data structures stored there to determine if the request can be granted.

If it can be granted, the filesystem simply adds the appropriate held-lock record to the list of byte range locks held on the file, and unlocks the relevant page.

If it cannot be granted, the filesystem to allocates an event object on which it can block the current user thread and calls into the Flow Scheduler (conditionAllocate( )) to allocate a condition variable object, passing in a callback routine and a pointer to a context block and receiving an opaque handle for that condition object. The context block will need to provide the callback routine a pointer to the event object on which the current user thread will block. It then stores a pending lock request record into the page containing the byte range lock data structures, which includes the condition variable's handle. The file system may then unlock the page containing the byte range lock data structures and blocks the user's lock request on the previously allocated event object until the callback routine is invoked.

3. When an application frees a byte range lock on a particular file, its local filesystem agent needs to acquire and lock an exclusive copy of the relevant byte range lock page(s). It removes the associated held-lock data structure from the list of lock records. It then searches the list of pending lock requests to determine if one or more of them can be satisfied. The filesystem is free to implement any queuing semantics that it desires, which means it can implement arbitrary lock ordering semantics. To grant a pending byte range lock, the filesystem removes the pending-lock request record from the list of pending requests, adds the appropriate record to the held-locks list, and uses the handle stored in the pending request record to wake up the user thread blocked waiting for the relevant byte range lock. The filesystem may signal zero or more pending lock requests in this manner.

4. When a signal request is received at a node, the remote operations element will allocate a master ED to perform the signal operation. The associated applet will use the handle to locate the condition variable object, from which it will extract the stored context block and callback routine, which it will invoke. The callback routine will simply signal the event corresponding to the condition variable, using information stored in the context block passed to it. This will cause the blocked user thread to be rescheduled, and the filesystem will complete the byte range lock request operation back to the user.

### Exemplary Programming Environment

As noted above, consumers make requests of the flow scheduler 10 via the API 30. The flow scheduler 10 provides a number of functions or applets for performing various tasks, and in one aspect the invention relates to a programming environment useful in generating code that is driven by the flow scheduler 10, that is, the generated code manages the execution of multiple, complex threads in a constrained environment requiring frequent blocking and unblocking of context threads. In one embodiment according to this aspect of the invention, such a programming environment or tool is invoked by typing a command line as follows:

applause [switches] inputFile [outputStem]

where “inputFile” is the name of the source file created using the language of this aspect of the invention and “outputStem” is the start of the name of the various output files generated according to this aspect of the invention. For example, if foo.clp was specified as the input file, the outputStem would default to foo. In certain embodiments, a stem of “foo” generates the following files:

foox.h This file is an external “include” file used to assemble parameters for calls through the opcode-based API 30. It contains the parameter classes for applets.

foo.h This file is an internal “include” file that includes interface classes for all defined applets. In addition, this file contains an inline function that can be used to invoke applets directly instead of via the opcode-based API 30.

foo.cpp This file contains C++ implementation of the member functions of the classes. There is one class defined for each applet that is derived from the interface class.

foo.clh This file is generated by each applet and defines an interface to be used when invoking the applet. When invoked, the name of the target applet would be looked up in a symbol table constructed from the applets defined in the local module and the public applets of the imported interfaces.

The “switches” allow a variety of options to be specified such as enabling/disabling completion sounds, command line syntax help, entering debug mode, and other common programming options. In some embodiments it is desirable to allow the switches to be interspersed anywhere throughout the command line. An exemplary list of switches follows.

-s enables completion sounds for the programming language;

-debug enables debugging mode;

-help displays help on the command line syntax;

-raisebreak enables generation of a breakpoint just prior to raising an exception;

-line enables generation of #line directives in the .cpp file; and

-Dname #DEFINE name from the command line.

An exemplary language of the invention is described below. Specifically, syntax and constructs for a language based on the C++ programming language are presented alphabetically. After the description of the language, a description of how the output files are generated is presented. These output files that are created according to the invention contain the actual code (for example, the applets and elements) used by the flow scheduler described in connection with FIGS. 1-4.

The input file is initially scanned for tokens that allow conditional compilation of the code. These are similar to preprocessor directives present in the C programming language. The following tokens must be at the beginning of the line to be interpreted.

| | |
|---|---|
| #DEFINE <name> | The provided name is defined. The -D switch on |
| | the command line is equivalent to a #DEFINE. |
| #IFDEF <name> | Includes the following code if <name> is defined |
| #IFNDEF <name> | Includes the following code if <name> is not |
| | defined. |
| #ELSE | A typical “else” token well-known in the art. |
| #ENDIF | Ends the #IFDEF. |

The language's syntax and constructs are presented below:

$ACTIVE_CHILD_COUNT

<active child embedded expression>::=$ACTIVE_CHILD_COUNT

This command provides the current number of child forks that have not yet been “waited.”

$ASYNC_EXCEPTION

<async exception embedded expression>::=$ASYNC_EXCEPTION

This command provides the current value of the async exception for this context thread, allowing the exception status for a context thread to be tested. If no asynchronous exception has been delivered to this context thread, the value is CLSTATUS_SUCCESS, that is, zero.

BLOCK

<block statement> : : =

BLOCK

<local variables>
<statement list>

ENDBLOCK

The BLOCK statement creates a scope for additional local variables to be declared. Local variables declared in the <local variables> clause are allocated and constructed on entry to the BLOCK. They are destroyed and deallocated on exit from the block statement. The statement implicitly generates an exception handler so that the storage is deallocated even when an exception is thrown from within the block. BLOCK statements can be arbitrarily nested. Variables in an inner scope can have the same names and occlude variables in an outer scope.

C++ Expression

Many syntax elements take a C++ expression that may be an arbitrary C++ value expression entered on separate lines and including comments. Included comments are removed and the expression collapsed onto a single line. The language should understand or tolerate nested parenthesis and allow the comma construct within a C++ expression. Whenever a C++ expression is parsed, it may be surrounded by parentheses so that the end of the C++ expression does not need to be explicitly detected.

C++ Comma Separated List

Some syntax elements may accept a C++ comma separated list; i.e., a list of arbitrary C++ code. The list may be assumed to be declarations or it may be assumed to be value expressions. The language should understand nested parenthesis with nested commas. The expressions within the comma separated list should not be required to be surrounded by parentheses. In all cases, the entire list is surrounded by parentheses.

APPLET

<applet scope> : : = PUBLIC

| PROTECTED
| PRIVATE

This command defines an applet within a module. Applets may have any one of three scopes: public, protected, or private. Public scope means that a public interface is exposed outside of the flow scheduler 10 via the “Consumer Request API (30)” and that there must be a OPCODE_xxx enumeration defined in some header X.h used by consumers to identify the public (exported) operation that they wish to invoke. An x.h file containing an inline function that can be used to invoke the applet in a natural fashion. An InvokeJxxx function prototype in the .h file and the corresponding function definition in the .cpp file that can be stored in the dispatch table may also be generated; i.e., it is not inline.

Protected scope means that only an interface is available to be called directly throughout the flow scheduler 10, but is not exposed outside of it. An example of this is shown in operation 2 of FIG. 4. An inline function is generated in the .h file to allow the applet to be called naturally.

Private scope means that the interface is only available within the module. Code generation is the same as for a protected interface, however, the class and function definitions are generated into the .cpp file, so they only resolve within the module.

Applet parameters and local variables should be specified using dollar identifiers. Local variables are scoped to the applet and are not visible outside of it. They may be used anywhere within it. Local variable and parameter names are in the same name space and will collide and generate warnings if they overlap.

The programming language may generate a number of names for applets. For example, the example below shows the various names generated for an applet named Jxxx:

Jxxx Generated if the applet is PUBLIC to provide an inline function of this name in the X.h file that invokes the applet through the InvokeApplet interface.

Jxxx An inline function that directly invokes the applet (not via InvokeApplet) is always generated in the .h file. The .h file (using the internal, direct call interface) or the X.h file (using the external, dispatched interface) may be included.

InvokeJxxx Generated in the .cpp file if the applet is PUBLIC to provide a global function of this name with a prototype in the .h file. This function should be stored in the dispatch table of InvokeApplet.

CL_OCODE_Jxxx Specifies the opcode used as a parameter to InvokeApplet to dispatch to this entrypoint.

DJxxx Defines all of the decomposed functions from the source code for the applet or element and is derived from the DInterfaceClass. Includes the “stack frame,” parameters, local variables, and possibly context.

DJxxxParams Class defined in the .h file that defines storage for the parameters to the Jxxx entrypoint. If it is a PUBLIC entrypoint, then the class is also defined in the X.h file.

CLEAR_EXCEPTION

<clear exception statement> : : =

CLEAR_EXCEPTION

Clears the currently active exception.

CLEAR_ASYNC_EXCEPTION

<clear async exception statement>::=CLEAR_ASYNC_EXCEPTION

Clears the async exception for this context thread. When an asynchronous exception is delivered to a context thread, it is sticky and remains active until the context thread completes or the exception is explicitly cleared.

ELEMENT

<element scope> : : = PROTECTED

| PRIVATE

<element> : : = <element scope>ELEMENT<entypoint body>
<entrypoint body> : : <entrypoint name><parameter list>

<entrypoint flags>
<local variables>
<statement list>
<end clause>

<entrypointflags> : : = NO_DESTRUCTOR

| <nothing>

<end clause> : : = ENDELEMENT
<local variables> : : =

LOCAL { <variables> }

Elements may be processed just like applets. In such an embodiment there is no reason to use one over the other. However, in other embodiments applets may be dynamically dispatched, which would result is different code for applets and elements. To ensure that the language accommodates both embodiments, appropriate keywords must be provided. Elements may not have PUBLIC scope and are never dispatched or directly visible through the API 30. Otherwise, the meaning of element scope has the same meanings as applet scope, described above.

CLOSE

<close statement> : : =

CLOSE <close clause>

<close clause> : : =

ALL

| ONE HANDLE (<C++ fork handle>) <close status>
<close status> : : =

STATUS (<C++ status>)

| <nothing>

This command closes one or all currently open fork handles. Fork handles are allocated when a context thread is forked. They are not deallocated when the thread completes; they need to exist so that completion status can be retrieved. Therefore, they must be specifically closed.

CODE

| | |
|---|---|
| <code statement> : : = | |
| {<applause C++>} | // any C++ code |

The code statement identifies a C++ block that is preserved as is in the output except for the substitution of dollar identifiers of parameters and variables with their data member references. The language should support either C++-style double slash comments or C-style slash-star comments.

$CURRENT_EXCEPTION

<current exception embedded expression> : : =

$CURRENT-EXCEPTION

For use in CATCH and FINALLY blocks, $CURRENT_EXCEPTION provides the value of the currently active exception. If there is none, it is CLSTATUS_SUCCESS; that is, zero.

#DEFINE

#DEFINE <identifier>

Defines a preprocessor symbol. Once defined, symbols cannot be undefined. Definition is in order by lexical scan. The only use of a preprocessor symbol is to be tested for whether it is defined or not:

#DEFINE BL4_DISK
#IFDEF BL4_DISK

{/* B14 special code here */}

#ELSE

{// BL3 version of the code here}

#ENDIF

The -D command line switch may also be used to define preprocessor symbols.

Dollar Identifier

In order to locate variables and parameters of interest within otherwise unprocessed C++ code, all variables and parameters should start with a dollar sign. This allows the language to be interpreted apart from C++ and allows the language to process arbitrarily scoped symbols.

Dollar identifiers must be valid C++ identifiers when the dollar is removed. To be formal dollar identifiers should: start with a dollar sign ($); have an alphabetic character (a to z or A to Z) as their second character; and include only alphabetic and numeric characters (a to z, A to Z, or 0 to 9) for all remaining characters, if any.

FOR

<for statement> : : =
FOR (<C++ statement> ; <C++ statement> ; <C++ statement>)
<statement list>
ENDFOR

The FOR command provides iterative flow control. The meanings of the clauses within the FOR statement are just like its C++ counterpart. The first is the loop initializer. The second is a boolean condition for loop continuation. The third is an end of loop action. In generated code, the FOR statement is decomposed into code fragments for the loop initializer and the end of loop action, and an if statement for the loop continuation condition.

The language should also allow semicolons within the C++ statements so long as they are syntactically valid. For example, in the loop initializer code, a parenthesized expression containing semicolons should be interpreted as valid.

```
FORK
<fork statement> : : =
      FORK <fork type> <entrypoint name> <parameter list> <fork
handle>
<fork handle> : : =
      HANDLE (<C++ fork handle>)
    | <nothing>
<fork type> : : =
      CHILD
    | DAEMON
    | <nothing>  // defaults to CHILD
```

The FORK command forks a child context thread or a daemon context thread (see FIG. 3). Fork of a daemon creates a separate context thread running in parallel to the current context thread. The daemon thread is completely independent of the creating thread. Any PUBLIC or PROTECTED applet or element may be started as a daemon.

Fork of a child invokes the entrypoint. If resources allow, a separate context thread is created running in parallel to the current context thread. However, that is not guaranteed. If resources are low, the FORK behaves just like an INVOKE: the current flow is stopped until the forked flow completes. Parallel algorithms implemented using forked children must be aware of this behavior and not create interdependencies between the parent and a child or between children, since they may not actually run concurrently.

Whether a child context process is forked or a daemon process is forked, FORK may optionally return a fork handle that can be used to wait for thread completion.

IF
<if statement> : : =

IF (<C++ expression>)
THEN <statement list>
<else clause>
ENDIF

<else clause : : =

ELSE <statement list>

| <nothing>

The IF statement provides structured flow control. IF statements may be arbitrarily nested. An else clause is optional. When code is generated from the IF statement, the sense of the boolean expression is reversed so that the ELSE case causes the branch and the THEN case falls through.

#IFDEF
#IFDEF <identifier>

...Applause statements used if <identifier> is defined as a

preprocessor symbol...
#ELSE

...Applause statements used if <identifier> is NOT defined...

#ENDIF

This statement is a preprocessor “if” statement to allow conditional inclusion of code at the programming language syntax level. The #ELSE clause and associated statements are optional.

#IFNDEF
#IFNDEF <identifier>

...Applause statements used if <identifier> is NOT defined as a

preprocessor symbol...
#ELSE

...Applause statements used if <identifier> is defined...

#ENDIF

This statement is a preprocessor “if” statement to allow conditional inclusion of code at the programming language syntax level. The #ELSE clause and associated statements are optional.

INCLUDE

<include> : : = INCLUDE <scope> <include element>
<scope> : : = PUBLIC

| PROTECTED
| PRIVATE
| <nothing> // default is PROTECTED
<include element> : : = <filename>

| { <C++ statements> } // any C++ code

<filename> : : =

<double quoted string>

| <angle quoted string>

This command passes an include directive or a code block directly through to the output. All include definitions may be collected together and placed at the front of the output files. If a filename is given then a # include of the file is generated keeping angle or double quotes intact. If C++ statements are specified, they are not processed in any way by Applause, but are passed through as is to the output files. If the scope is PUBLIC, the text is written to the X.h file and the .h file; it is for external use and is also made available internally. If the scope is PROTECTED, the text is written to the .h file; it is for internal use. If the scope is PRIVATE, the text is written to the .cpp file; it is private for this module.

INVOKE
<invoke statement> : : =

INVOKE <return status> <entrypoint> <argument list>

<return status> : : = <dollar identifier> =

| <nothing>

<entrypoint> : : =

<applet name>

| (<C++ expression>)

This command invokes an applet or element entrypoint. If return status is specified, then the return status of the invoked applet or element is assigned to the parameter or variable identified by the dollar identifier. Generation of code for an invoke should specify the applet name and the argument list with appropriate dollar identifier substitutions.

```
LABEL
<label statement> : : =
  LABEL <label name>
  <statement list>
  ENDLABEL
```

Label statements provide semi-structured branching and allows escape from loops and complex IF statements. The label statement does not generate code in and of itself, but instead provides a structured target for the leave statement. Label-leave pairs may be used similarly to code break, continue, and goto statements in C++. The label name must be unique within the label scope, but may be re-used at the same scope, i.e., label statements that use the same label name may not be nested, the inner one will be ignored.

LEAVE
<leave statement> : : =
LEAVE <label name>

Leave statements, in conjunction with labels, provide semi-structured branching. It is most useful for escaping from loops and complex if statements. Leave statements should be nested within a label block with a matching label. The match is case-sensitive.

LOCAL
LOCAL {

<variable declaration> ...
}

<variable declaration> : : =

<C++ stuff> <dollar identifier> <constructor>

<constructor> : : =

(<C++ expression comma list>)

| <nothing>

The LOCAL command declares local variables at an applet level or within a BLOCK statement. Variables from one nested scope may occlude variables in an outer scope.

LOCK
<lock statement> : : = <when clause>

LOCK <lock mode> (<DLockContext* expr>)
<statement list>
ENDLOCK

```
<when clause>
      WHEN (<C++ boolean expr>)
    | nothing
<lock mode>
      SHARED
    | EXCLUSIVE
    | <nothing>  // defaults to EXCLUSIVE
```

The LOCK statement allows the programming language to provide structured locking. An applet may pend until an acquired lock can be granted. Once the lock is granted, the statement list associated with the LOCK statement is executed. The LOCK-ENDLOCK scope should create an exception handler so that exceptions from within the block will flow to the handler and the lock will be unlocked in all cases on exit from the block. This should be done implicitly.

The WHEN clause should only be used with a DLockContextWhen derivative of the DLockContext. That is made by constructing the DLockContextWhen with a DLockWhen. The lock is not granted until the boolean expression returns true and the lock is available.

The <lock mode> should have an effect only when used with a DLockContextSync derivative of the DLockContext. That can be accomplished by constructing the DLockContextSync with a Dsync. The lock is acquired in the specified mode.

```
MODULE
IMPLEMENTATION MODULE <module name>
    <module definitions>
    ENDMODULE
```

Modules may be either implementation modules or interface modules. Modules contain module definitions. Module definitions are INCLUDE, TRACE, APPLET and ELEMENT definitions, as described above. The module name may be used within the generated code for some macro naming.

No_Destructor

The NO_DESTRUCTOR flag on an applet or element declaration should inhibit the programming language from generating calls to the destructor for the object derived from DInterfaceCled. The NO_DESTRUCTOR flag should be set only on applets or elements having top-level local variables and parameters that do not need to be destructed. For example, if an applet or element accepts pointers or references as parameters, and all variables defined in the applet or element are integers, no destructor is necessary.

Parameter

Parameters are dollar identifiers. During code generation, parameters should be changed to references to member data. For example, $x, should become m_apParam.x in the generated code.

RAISE
<raise statement> : : =
RAISE (<C++ expression>)

This command raises an exception. The exception can be caught and handled in TRY blocks. Unhandled exceptions should cause applets to complete and control to flow up the ED stack. An exception may be implemented as simply a STATUS.

$RAISE
<raise embedded statement> : : =
$RAISE (<C++ expression>)

This command raises an exception from within C++ code. That is, it causes the equivalent behavior of a RAISE statement, but it is executed within a C++ code block.

RAISE_IF_ASYNC_EXCEPTION
<raise statement> : : =
RAISE_IF_ASYNC_EXCEPTION

This is an optional command that raises the async exception as the current exception if an async exception has been delivered to this context thread. This statement is optional because it is provided as a convenience. It is functionally equivalent to:

IF ($ASYNC_EXCEPTION!=STATUS_SUCCESS)

THEN RAISE ($ASYNC EXCEPTION)

ENDIF

RERAISE
<reraise statement> : : =
RERAISE

This command raise the current exception again. RERAISE is used within CATCH blocks to signal that the CATCH block cannot entirely handle an exception and to allow the exception to be processed through outer TRY blocks.

RETURN
<return statement> : : =
RETURN (<C++ expression>)

The RETURN command completes the applet and returns execution control to the previous ED context or back to the invoker. The programming language should require a return statement on every exit path from the applet. An expression should be supplied as the return value.

$RETURN
<return embedded statement> : : =
$RETURN (<C++ expression>)

A RETURN statement causes the equivalent behavior of a RETURN statement, but executed within a C++ code block, i.e. a return from an applet is executed within C++ code.

```
SWITCH
<switch statement> : : =
    SWITCH (<C++ expression>)
    <case clause>
    <default clause>
    ENDSWITCH
CASE (<case expression>) : <statement list>
<case expression> : : =
    <C++ compiletime constant expr>
  | <C++ compiletime constant expr, <case expression>
<default clause> : : =
    DEFAULT: <statement list>
```

The SWITCH statement provides structured flow control. The language may choose to implement this command using a C++ “switch” statement. All of the C++ rules for the case switch expression and the case expressions may apply and .the body of each case may be any arbitrary statements.

Unlike a C++ switch statement, all cases implicitly “break” at the end and flow to the statement following the ENDSWITCH. Also, to specify multiple cases, you provide a comma-separated list of expressions to a single CASE statement, rather than provide a list of CASE statements.

Statement

A statement is one element of an applet. Lists of statements may be terminated by explicit ENDxxx constructs. Statements can optionally be terminated with a semicolon but should not be required syntactically.

TRACE

<trace>::=TRACE <trace type>

The trace clause sets the trace name to be used for this module compilation. Only one TRACE declaration should be made. The <trace type> is used to generate the trace name. For example, the default type is APPLET. Exit from the applet may be traced using:

PRINT_EXIT(DEBUG_ENGINE_APPLET, 50,

“Exiting <clapname>−return(0x % 08x)”, <status>);

Entry to an applet function may be traced using:

PRINT ENTRY(DEBUG_ENGINE APPLET, 60,

“Entering <clapFn name>”);

```
TRY
<try statement> : : =
    TRY
    <statement list>
    <handler clause>
    ENDTRY
<handler clause> : : =
    FINALLY <statement list>
  | CATCH <statement list> // use $CURRENT_EXCEPTION
```

The TRY command provides structured exception handling. The programming language should not allow TRY statements can be arbitrarily nested and should not allow a RETURN statement from within a TRY, since a RETURN completes the executing applet and destroys the TRY stack within that execution context. TRY-FINALLY code should not be executed because exception state may be lost.

The semantics of a TRY-CATCH are that the CATCH statement list is executed only when an exception is raised in processing the TRY statement list. In the normal success flow, the CATCH statement list is not executed.

The semantics of a TRY-FINALLY are that the FINALLY statement list is always executed, either on the normal success flow after the final statement of the TRY statement list, or when an exception is raised. The $CURRENT EXCEPTION value can be used to distinguish the exception case (!=0) from the success case.

```
UNLOCK
<unlock statement> : : =
    UNLOCK <unlock context>
    <statement list>
    ENDUNLOCK
<unlock context> : : =
    (DLockContext* expr)
  | <nothing>
```

The UNLOCK command provides a scope within a LOCK-ENDLOCK statement where the lock is released and later reacquired. Accordingly, if the UNLOCK statement appears in the same applet nested within a LOCK statement, then it is not necessary to provide the unlock context. It is implicitly the lock of the encompassing LOCK statement.

The UNLOCK statement can be used within a subroutine applet, in which case, the DLockContext* must be passed as a parameter into the subroutine applet and specified on the UNLOCK statement.

The UNLOCK-ENDUNLOCK scope should implicitly create an exception handler so that exceptions from within the block will flow to the handler and the lock will be relocked in all cases on exit from the block.

Variable

Variables are dollar identifiers. During code generation, variables are changed to references to member data. For example, $x, becomes m_clapVar.x in the generated code.

WAIT

<wait statement> : : = WAIT <wait clause>
<wait clause> : : =

ALL

| ONE HANDLE (<C++ fork handle>) <wait status>
| ANY HANDLE (<C++ fork handle>) <wait status>

<wait status> : : =

STATUS (<C++ expression>)

| <nothing>

This command waits for one or more daemon or child context threads to complete. Waits may be for one, one of a set, or all currently open fork handles. Fork handles are allocated when a context thread is forked.

Whitespace

Whitespace means space, tab, newline, vertical tab, and form feed characters. These should be ignored by the programming language with one exception. A double slash comment should always be terminated by a newline character.

Other command and programming constructs may be defined in order to extend the basic language outlined above.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

What is claimed is:

1. An apparatus for executing multithreaded, blocking, application-like functionality in kernel space, the apparatus comprising:
a work queue manager assigning a context thread representing at least a portion of the application-like functionality to a kernel thread for execution;
a buffer manager allocating memory for use by the kernel thread; and
a threading manager providing a context object associated with the kernel thread, the context object representing at least a portion of context thread work to be performed.

2. The apparatus of claim 1 wherein the threading manager provides a plurality of context objects and wherein one of the plurality of context objects is created at a control transfer point in the context thread execution flow.

3. The apparatus of claim 1 further comprising a synchronization manager providing a general purpose synchronization object used by the context thread to protect access to a system resource.

4. The apparatus of claim 3 wherein the synchronization object is provided with two separate states: locked and bound.

5. The apparatus of claim 1 further comprising a timer providing a time-out indication.

6. The apparatus of claim 1 wherein the buffer manager allocates memory using heap storage.

7. The apparatus of claim 1 wherein the buffer manager provides a buffer pool comprising fixed-size buffers.

8. The apparatus of claim 1 wherein the buffer manager provides a page pool comprising fixed-size, block-aligned storage objects.

9. The apparatus of claim 1 wherein the buffer manager provides a heap pool comprising variably-sized memory objects.

10. The apparatus of claim 1 further comprising a dispatcher/loader receiving a request and creating a context thread to service the request.

11. A data structure associated with a context thread executing in kernel space, the data structure comprising:
a definition flag stored in a memory element, said definition flag defining the associated context thread;
an execution flag stored in a memory element, said execution flag controlling execution of the associated context thread;
a pointer stored in a memory element indicating the currently executing context thread; and
an address indicator stored in a memory element which stores the address of the associated context thread.

12. The data structure of claim 11 further comprising a status indicator stored in a memory element.

13. The data structure of claim 11 further comprising an exception indicator stored in a memory element.

14. A method for allowing in-kernel execution of multithreaded, blocking, application-like functionality, the method comprising the steps of:
(a) associating a data structure with a context thread representing at least a portion of multithreaded, blocking, application-like functionality to be executed, the data structure stored in a memory element;
(b) storing context thread state in the data structure associated with the context thread; and
(c) executing, responsive to the data structure, the context thread as one of a number of kernel threads executing on a processor.

15. The method of claim 14 further comprising the step of retrieving context thread state from the data structure associated with the context thread.

16. The method of claim 14 wherein step (b) further comprises:
(b-a) allocating, in response to a procedure call, memory space used by the context thread to store local variables and temporary computation space; and
(b-b) storing an indication of the allocated memory space in the data structure associated with the context thread.

17. The method of claim 14 further comprising the step of generating a duplicate of the context thread by duplicating the data structure associated with the context thread.

18. An article of manufacture having computer-readable program means embodied therein, the article comprising:
(a) computer-readable program means for associating a data structure with a context thread representing at least a portion of multithreaded, blocking, application-like functionality to be executed, the data structure stored in a memory element;
(b) computer-readable program means for storing context thread state in the data structure associated with the context thread; and
(c) computer-readable program means for executing, responsive to the data structure, the context thread as one of a number of kernel threads executing on a processor.

19. The article of claim 18 further comprising computer-readable program means for retrieving context thread state from the data structure associated with the context thread.

20. The article of claim 18 wherein the computer-readable storing means further comprises:
(b-a) computer-readable program means for allocating, in response to a procedure call, memory space used by the context thread to store local variables and temporary computation space; and
(b-b) computer-readable program means for storing an indication of the allocated memory space in the data structure associated with the context thread.

21. The article of claim 18 further comprising computer-readable program means for generating a duplicate of the context thread by duplicating the data structure associated with the context thread.
